(19) United States
(12) Patent Application Publication
(10) Pub. No.: US 2009/0059013 A1
(43) Pub. Date: Mar. 5, 2009

(54) METHOD FOR INTERACTIVELY TRANSFERRING VIDEO BY THE NETWORK CAMERAS OR NETWORK VIDEO SERVERS

(75) Inventor: Che-Sheng Yu, XiZhi City (TW)

Correspondence Address: ANTHONY R. BARKUME, 20 GATEWAY LANE, MANORVILLE, NY, 11949, US

(73) Assignee: Imagia Technologies, XiZhi CIty (TW)

(21) Appl. No.: 12/133,816

(22) Filed: Jun. 5, 2008

(30) Foreign Application Priority Data
Aug. 29, 2007 (TW) 096132162

(51) Int. Cl. H04N 5/225

(52) U.S. Cl. 348/207.1; 348/E05.024

(57) ABSTRACT

The present invention relates to a method for interactively transferring video on the network video cameras or network video servers, which contains the following steps: providing a network camera or network video server; transferring a first video signal from the network camera or network video server to a first computer through a network; translating this first video signal to a first video image and displaying it onto the first computer; newly generating a drawing pattern and pasting it onto the first video image by covering; transferring a second video signal from the network camera or network video server to a second computer through a network; translating this second video signal to a second video image and displaying it onto the second computer; newly generating a drawing pattern and pasting it onto the second video image by covering.

### FIELD OF THE INVENTION

The present invention relates to a method for interactively transferring video by the network cameras or network video servers, especially for multiple users who receive video data that transferred from the same network camera or network video server, and they can add a drawing pattern on these video data and achieve the interactive activities by transferring these video data to each others.

### BACKGROUND OF THE INVENTION

The traditional network camera or network video server are different from general cameras or video servers. The traditional network camera is able to transfer the video data through the network by their built-in network server without an external computer. Users just need to use a device connecting with network and they are able to browse the captured video from a network camera.

FIG. 1 is the block diagram of a traditional network camera, which contains a network camera 11, an internet network 12, a first user 13, a second user 14, and a third user 15.

The traditional network camera 11 supports built-in web server function and contains many advantages, but can only support the video data transferring from the network camera 11 to and among the first user 13, the second user 14 and the third user 15; this architecture cannot support the first user 13, the second user 14, and the third user 15 to communicate and interact each other through this internet network 12. For example, users can't add any comments onto the video image.

Especially for the distance learning application of the network camera, users cannot add any circles or drawings onto the video images directly between students and teachers or students and students. This is very inconvenient. The traditional interactive solution can only supported by the other texture or audio communication software applications through internet. But the video image usually cannot be described very easily by texture or conversation, for example, when we would like to describe a particular section of a video image, if we can have interactive activities on the captured video by drawing pattern, such as drawing a particular part of a video image to describe it, then we may enhance the performance of interactive communication discussion.

There are several disadvantages in the traditional technologies:

1. The video image can be only transferred from the network camera to the user ends by the traditional network camera video transferring solution.
2. Users who are viewing the video image cannot communicate interactively by transferring drawing patterns to each other via the traditional network camera video transferring solution.
3. There is no efficiency to describe video image by the traditional texture or voice communication solutions.

Therefore, how to improve the above traditional disadvantages to allow users who are viewing video images be able to communicate to each other by transferring drawing patterns, is the major topic of the present invention.

### SUMMARY OF THE INVENTION

An objective of the present invention is to provide a new and advanced interactive solution of transferring video by the network camera, which is based on the video image that is captured by a network camera to draw a drawing pattern, and transfer this drawing pattern to another computer through internet, and then newly generate a drawing pattern and past it onto the video image that is transferred by the network camera by covering, to achieve interactive activity.

### BRIEF DESCRIPTION OF THE INVENTION

According to the present invention, a method for interactively transferring video by the network camera comprises following steps:

providing a network camera;

transferring a first video signal from the network camera to a first computer through a network;

forming a first video image based on the first video signal and displaying the first video image onto the first computer;

appending a drawing pattern and pasting the drawing pattern onto the first video image displayed on the first computer;

transferring a second video signal from the network camera to a second computer through the network;

forming a second video image based on the second video signal and displaying the second video image onto the second computer;

transferring the video signal of the drawing pattern from the first computer to the second computer through the network;

pasting the drawing pattern onto the second video image displayed on the second computer.

In accordance with one aspect of the present invention, the first video signal and the second video signal are the same video signal.

In accordance with one aspect of the present invention, the video signal of the drawing pattern comprises a location and color parameters of the drawing pattern.

In accordance with one aspect of the present invention, the way to transfer the video signal of the drawing pattern to the second computer is through the network.

In accordance with one aspect of the present invention, the way to transfer the video signal of the drawing pattern to the second computer is through the network camera.

In accordance with one aspect of the present invention, the pasting method is implemented by the OSD (On Screen Display) technology.

In accordance with one aspect of the present invention, the first computer transfers the video signal of the drawing pattern to a third computer dependently.

In accordance with one aspect of the present invention, the third computer displays out the drawing pattern dependently.

In accordance with one aspect of the present invention, the method is used as the application of long distance learning.

In accordance with one aspect of the present invention, the network is an Internet network.

The present invention may best be understood through the following description with reference to the accompanying drawing patterns, in which:

### BRIEF DESCRIPTION OF THE DRAWING

FIG. 1 shows the diagram of a traditional network camera;

FIG. 2 shows the flow chart of the interactive solution of transferring video by the network camera according to the present invention;

FIG. 3 shows the diagram of the interactive solution of transferring video by the network camera by the network camera according to the present invention;

FIG. 4 shows the diagram of the interactive solution of transferring video by the network camera directly according to the present invention;

FIG. 5 shows the diagram of the interactive solution of transferring video by the network camera according to the present invention.

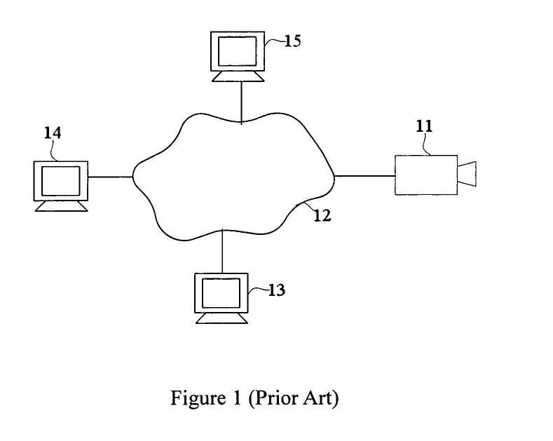

### DETAILED DESCRIPTION OF THE PREFERRED EMBODIMENT

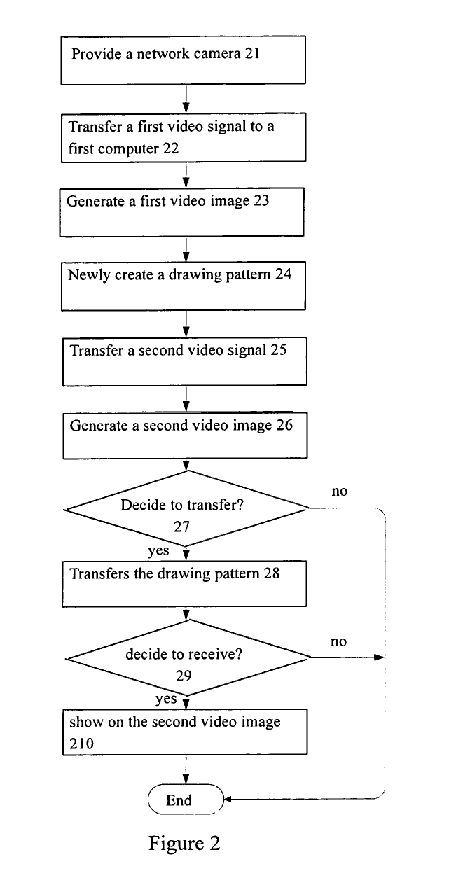

FIG. 2 shows the flow chart of the interactive activity according to the present invention for transferring video image by the network camera or network video server, which contains the following steps:

Step 21: Providing a network camera or a network video server;

Step 22: Transferring a first video signal to a first computer;

Step 23: Generating a first video image;

Step 24: Newly creating a drawing pattern on the first video image and covering thereon;

Step 25: Transferring a second video signal to a second computer;

Step 26: Generating a second video image;

Step 27: The first computer decides to transfer the drawing pattern to the second computer or not;

Step 28: The first computer transfers this drawing pattern;

Step 29: The second computer decides to receive this drawing pattern or not;

Step 210: The drawing pattern shows on the second video image and covering thereon.

First of all, provide a network camera (or a network video server) in Step 21. Then transfer a first video signal to a first computer through internet in Step 22. When the first computer receives the first video signal that is transferred by the network camera (or network video server), the first video signal will be generated as a first video image in the Step 23, and this first video image will be displayed on the screen of the first computer; the user of the first computer would be able to newly create a drawing pattern based on the first video image in the Step 24. For example, the user can newly add a circle or draw a line on the particular area of the drawing pattern, and pasting this drawing pattern on the first video image. At this moment, the network camera (or the network video server) also transfers a second video signal to a second computer through internet in the Step 25. When the second computer receives the second video signal, it will generate this second video signal as a second video image in the Step 26, and displays it on the screen of the second computer. On the other hand, after the first computer newly creates the drawing pattern, it will be able to set whether to transfer this drawing pattern to the second computer or not. The first computer would be able to decide this drawing pattern will be transferred to which computers. After setting completely, this drawing pattern will be transferred to the destination computer in Step 28. If the first computer follows the setting value and transfers the drawing pattern to the second computer, the second computer might follow the previous setting value to decide to receive this drawing pattern that is transferred from the first computer or not. After the second computer decides to receive this drawing pattern, the second computer will display it onto the screen by pasting mode in the Step 210. Therefore, the newly created drawing pattern by the first computer will be pasted onto the original second video image that is displayed on the second computer, and the second computer will be able to understand the contain that is shown by the user of the first computer of the integrated drawing pattern and the second video image. For example, according to the drawing pattern or the circle transferred from the first computer, we may understand what the first computer tries to describe is on the video image. Of course, if the transportation throughput of the network is very fast, then the time shift between the first video image of the first computer and the second video image of the second computer will be very short to ignore it. Therefore, when the second computer displays the drawing pattern that is added by the first computer, it will not have too much difference from the video image that is drawn and displayed by the first computer at the early beginning. So, this solution is able to approach the well communication performance by transferring the drawing patterns. Further more, the solution of displaying drawing patterns by pasted method can easily implemented by using the OSD (On Screen Display) technology.

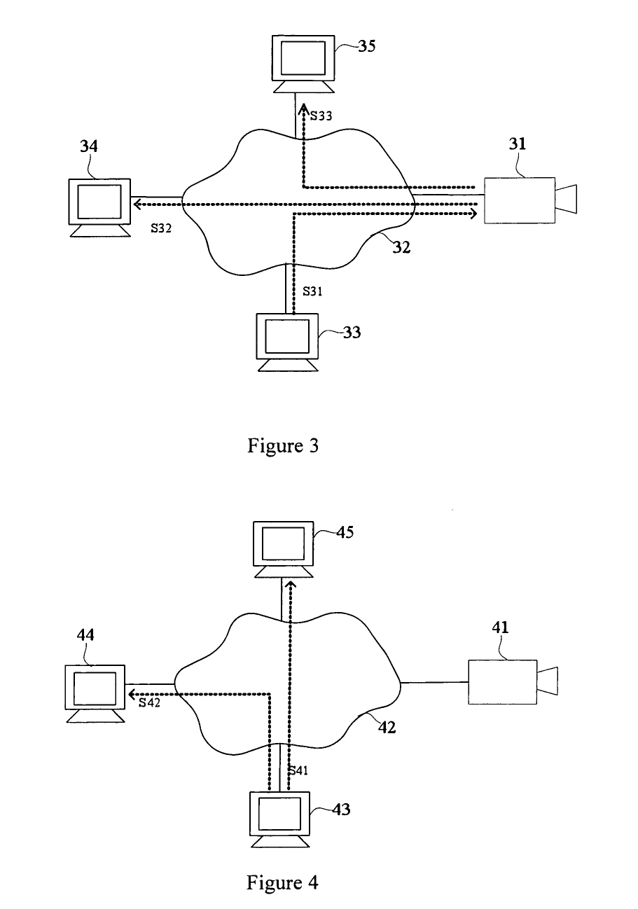

FIG. 3 shows the drawing pattern of the interactive activity during the video transferring by the network cameras according to the present invention that transfers drawing patterns through the network cameras, which contains a network camera 31 (or a network video server), an internet network 32, a first user 33, a second user 34, and a third user 35.

FIG. 4 shows the diagram of the interactive activity during the video transferring by the network cameras according to the present invention that transfers drawing patterns directly, which contains a network camera 41, an internet network 42, a first user 43, a second user 44, and a third user 45.

In accordance with a method for interactively transferring video by the network cameras of the present invention, there are two proposals for transferring drawing patterns to the other computers: the first transferring proposal is using master-slave network architecture, as the first user 33 has to transfers the drawing pattern to the network camera 31 (or network video server) through the internet network 32 firstly, and then transfers this drawing pattern to the second user 34 and the third user 35 via this network camera 31 (or network video server) during transferring a drawing pattern out. The second transferring proposal is using peer-to-peer network architecture. That is, the first users 43 transfers the drawing pattern to the second user 44 and the third user 45 directly through the internet network 42 without the network camera 41 during transferring a drawing pattern out.

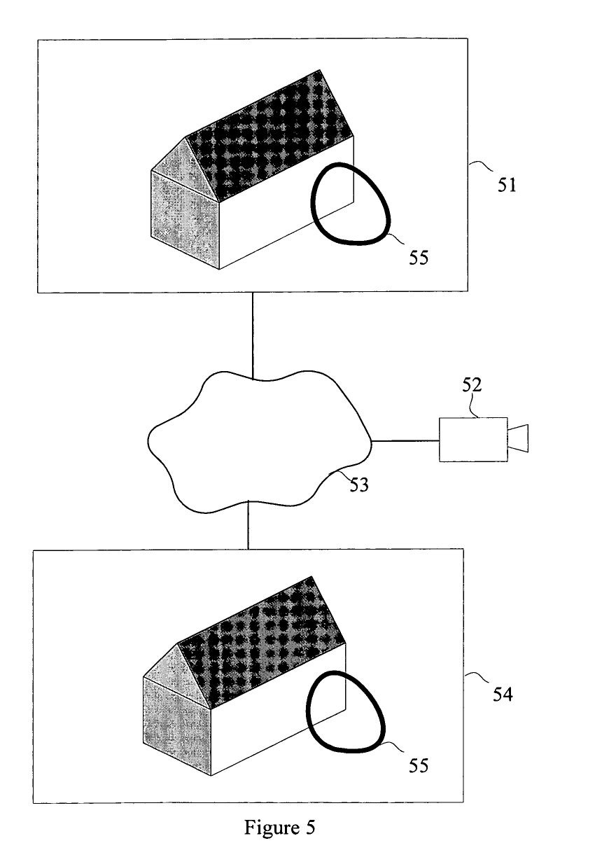

FIG. 5 shows the diagram of the interactive activity during the video transferring by the network cameras according to the present invention, which contains a first user 51, a network camera 52 (or a network video server), an internet network 53, a second user 54, and drawing pattern 55.

In accordance with FIG. 5 of the present invention, network camera 52 (or network video server) is able to transfer the captured house image to the first user 51 and the second user 54, and displays the house image on the computer screens of the first user 51 and the second user 54. Based on the house image that is displayed on the screen the first user 51 is able to newly create a drawing pattern 55, for example, newly creating a circle on the screen by a mouse, and transferring this drawing pattern 55 to the second user 54 after newly created. The second user 54 is able to display this drawing pattern 55 on the computer screen by pasting after receiving it. Therefore, the first user could be able to newly create drawing patterns and transfer it to the second user for displaying on the computer screen, to approach the communication between the first user and the second user.

There are several advantages of the present invention:

1. The interactive solution of transferring video by the network camera that is provided by the present invention could be able to transfer drawing patterns between users very interactively.

2. The interactive solution of transferring video by the network camera that is provided by the present invention would be able to improve the interactive efficiency by the communication way of drawing pattern style, to avoid the inconvenient communication solution by texture or speech way.

In accordance with the interactive solution of transferring video by the network camera of the present invention, it would be able to use as the applications of requiring video capturing and communicating through Internet network, such as distance learning or distance monitoring.

To sum up, the interactive solution of transferring video by the network camera according to the present invention is using the way to draw drawing pattern on the video image transferred by the network camera, transferring the drawing pattern to another computer through internet network, displaying this drawing pattern onto the screen of another computer by pasting method, to achieve the interactive activity. All the design changes that based on the theory of the present invention, just likes the different types of video signals, drawing pattern different drawing patterns, or pasting these drawing patterns onto the video images by another solutions, are covered by the present invention if the interactive activities use the network to transfer drawing patterns.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for interactively transferring video by the network camera comprising following steps:
providing a network camera;
transferring a first video signal from the network camera to a first computer through a network;
forming a first video image based on the first video signal and displaying the first video image onto the first computer;
appending a drawing pattern and pasting the drawing pattern onto the first video image displayed on the first computer;
transferring a second video signal from the network camera to a second computer through the network;
forming a second video image based on the second video signal and displaying the second video image onto the second computer;
transferring the video signal of the drawing pattern from the first computer to the second computer through the network;
pasting the drawing pattern onto the second video image displayed on the second computer.

2. A method according to claim 1 wherein the first video signal and the second video signal are the same video signal.

3. A method according to claim 1 wherein the video signal of the drawing pattern comprises a location and color parameters of the drawing pattern.

4. A method according to claim 1 wherein the way to transfer the video signal of the drawing pattern to the second computer is through the network.

5. A method according to claim 1 wherein the way to transfer the video signal of the drawing pattern to the second computer is through the network camera.

6. A method according to claim 1 wherein the pasting method is implemented by the OSD (On Screen Display) technology.

7. A method according to claim 1 wherein the first computer transfers the video signal of the drawing pattern to a third computer dependently.

8. A method according to claim 7 wherein the third computer displays out the drawing pattern dependently.

9. A method according to claim 1 wherein said method is used as the application of long distance learning.

10. A method according to claim 1 wherein the network is an Internet network.
